(19) United States
(12) Patent Application Publication
(10) Pub. No.: US 2025/0292246 A1
(43) Pub. Date: Sep. 18, 2025

(54) SYSTEM, DEVICE AND METHOD FOR VERIFYING PAYMENT VALIDITY

(71) Applicant: NAYAX LTD., Herzliya (IL)

(72) Inventors: David BEN-AVI, Herzliya (IL); Guy ROSENHOIZ, Herzliya (IL)

(21) Appl. No.: 18/862,654

(22) PCT Filed: Jun. 14, 2023
(86) PCT No.: PCT/IL2023/050615

§ 371 Date: Nov. 4, 2024

(30) Foreign Application Priority Data
Jun. 21, 2022 (IL) 294174

(51) Int. Cl. G06Q 20/38; G06Q 20/32; G06Q 20/36

(52) U.S. Cl. CPC G06Q 20/3829; G06Q 20/3278; G06Q 20/36; G06Q 20/3827

(57) ABSTRACT

A payment terminal comprising one or more tangible computer-readable non-transitory storage media comprising program instructions for verifying payment validity, wherein execution of the program instructions by one or more processors cause the payment terminal to: receive a payment token issued by a software development kit (SDK) located at a wireless device, wherein the payment token includes a first public key of a pair of Public-Private keys and a consumer identifying information; generate a payment request including transaction information message and transmit said first payment request message and said payment token to an at least one back-end platform to be stored in at least one database; and receive the payment and a transaction confirmation message from said at least one back-end platform based on a payment approval generated by said at least one back-end platform, wherein verifying ownership of said first public key is done at least one back-end platform based on comparison of the public key of the signed transaction information message and said public key of the payment token.

### TECHNICAL FIELD

Some described herein generally relate to methods, systems, and apparatus for verifying payment validity. More specifically, the disclosure is related to a verification of financial transactions.

### BACKGROUND

It is widely known that payment cards such, for example, as credit cards and debit cards are susceptible to fraud while proving highly advantageous to both consumers and businesses.

Fraud prevention and the formation of a secure purchase environment for payment cardholders were the aim of many efforts in the field since the establishment of payment cards in the 20th century.

The Eourepay, Visa, Mastercard (EMV) standard enables verification of a cardholder identity via a secure transmission of the payment card number and a 4-digit PIN number from a Merchant point of sale (POS) for verification by the card issuer. Once the details of the payment card number and a 4-digit PIN, the date of expiration are exposed to an unauthorized person, this person may use the credit card for purchasing goods and services.

Thus, there is a need for a more secure system and method to cure the above mention deficiencies.

### SUMMARY

The present invention related to a system, a method, and a product for verifying payment validity are described hereinbelow by the ways of example only.

According to an aspect of the presently disclosed subject matter, the invention may include a payment terminal comprising one or more tangible computer-readable non-transitory storage media comprising program instructions for verifying payment validity, wherein execution of the program instructions by one or more processors causes the payment terminal to: receive a payment token issued by a software development kit (SDK) located at a wireless device, wherein the payment token includes a public key of a Public-Private key pair; generate a payment request including a transaction information message and transmit said payment request and said payment token to an at least one backend platform to be stored in at least one database; and receive the payment and a transaction confirmation message from said at least one back-end platform based on a payment approval by said at least one back-end platform, wherein verifying ownership of said public key is based on comparison of the public key of the transaction information message signed by a private key in a wireless device and said public key of the payment token by the at least one back-end platform.

For example, wherein, said program instructions of said storage media, comprising: transmitting a hash value of said transaction information message to the wireless device that initiated said payment; wherein, the transaction confirmation is received after the wireless device compares the transaction verification message against said hash value of said transaction information message.

For example, wherein said program instructions of said storage media when executed, result in: receiving said payment token via at least one of: a Radio Frequency Identification (RFID) communication, a short-range radio communication and a Near Field Communication (NFC).

For example, wherein said consumer identifying information of said payment token comprises at least one of: a random number stored in said at least one back-end platform, a hash value of information associated with a user, a unique serial number.

For example, wherein said transaction information comprises at least one of a payment due, a product list, and a merchant ID.

One embodiment may include a method for verifying payment validity comprising: providing a Public-Private key pair by a wireless device; said wireless device generating a payment token that includes a public key of said Public-Private key pair and a consumer identifying information; said wireless device providing said payment token to a payment terminal at a point of sale; said payment terminal generating a first payment request message that includes a transaction information message of a payment and transmitting the payment request message and said payment token to an at least one back-end platform; generating a transaction verification message by said at least one back-end platform from said transaction information message; providing the transaction verification message to a device associated with said public key of said payment token; signing said transaction verification message with a private key of said public-private key pair and sending the signed transaction verification message to said at least one back-end platform; verifying ownership of said first public key by comparing a second public key provided by the second transaction information signed by a private key in a wireless device against said first public key is done by the at least one back-end platform; approving said transaction with a customer platform of an at least one financing entity; informing said payment terminal, wireless device, and said customer platform of payment verification result by said at least one back-end platform sending a transaction confirmation message from said at least one back-end platform.

For example, wherein said consumer identifying information of said payment token is at least one of the following: a random number stored in said at least one back-end platform, a hash value of information associated with a user, a unique serial number.

For example, wherein said transaction information comprises at least one of a payment due, a product list, and a merchant ID.

For example, wherein said payment token is generated by: generating a private key that is a random number; generating a public key by hashing said private key; hashing consumer identifying information that includes at least one of the following: consumer contact information, wireless device ID, payment information, geolocation, and consumer id number; constructing said payment token with said public key and the hash value of the consumer identifying information.

One other embodiment may include a wireless device comprising one or more tangible computer-readable non-transitory storage media having installed an application comprising program instructions for verifying payment validity, wherein execution of the program instructions by one or more processors results in: providing a Public-Private key pair; generating a payment token that includes a public key of said Public-Private key pair; provide a payment terminal of said point of sale with said payment token; receive a transaction information message from said payment terminal; receive a transaction verification message from at least one back-end platform; based on comparison of the transaction verification message and the transaction information message, sign said transaction verification message with a private key of said public-private key pair, sending it to said at least one back-end platform; receive a transaction confirmation after verifying ownership of said public key based on comparison of the public key of the signed transaction message and said payment token, wherein said transaction confirmation is received after approving said transaction with a customer platform of at least one financing entity.

For example, wherein said payment token comprising a consumer identifying information that includes at least one of the following: a random number stored in said at least one back-end platform, a hash value of information associated with a user.

For example, wherein said program instructions of said storage media, when executed, result in: generating a payment token before each payment to be verified.

For example, wherein said program instructions of said storage media, when executed, result in: generating a private-public pair upon first registration of a consumer with said at least one back-end platform.

For example, wherein said program instructions of said storage media, when executed, result in: importing an existing Public-Private key pair for use in said payment token.

For example, wherein said program instructions of said storage media, when executed result in: signing said transaction verification message on the event of at least one of the following: unlocking said wireless device, when a geolocation of the wireless device is similar to a geolocation of a payment terminal, and a transaction to be signed does not exceed a pre-set money allowance.

For example, wherein said program instructions of said storage media, when executed, result in: generating a private key that is a random number; generating a public key by hashing said private key; hashing consumer identifying information that includes at least one of the following: consumer contact information, wireless device ID, payment information, geolocation, and consumer id number; constructing said payment token with said public key and the hash value of the consumer identifying information.

Various objects, features, and aspects of the present invention will become more apparent from the following detailed description of preferred embodiments of the invention, along with the accompanying drawings in which like numerals represent like components.

### BRIEF DESCRIPTION OF THE DRAWING

In order to better understand the subject matter that is disclosed herein and to exemplify how it may be carried out in practice, embodiments will now be described, by way of non-limiting example only, with reference to the accompanying drawings, in which:

FIG. 1 illustrates a block diagram of a system for verifying payment validity, according to some demonstrative embodiments.

FIG. 2 illustrates a flowchart of a method for verifying payment validity, according to some demonstrative embodiments.

FIG. 3 illustrates a flowchart of a method for verifying payment validity, according to some demonstrative embodiments.

FIG. 4 illustrates a flowchart of a method for verifying payment validity, according to some demonstrative embodiments.

FIG. 5 illustrates a product of manufacture according to some demonstrative embodiments.

FIG. 6 illustrates a block diagram of a system for verifying payment validity, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to one or more processors, e.g., as necessary to execute the logic.

The term “module,” as used hereinbelow, is an object file that contains code to extend the running kernel environment.

As used herein, the term “software engine” as used hereinbelow is an object file that contains code to extend the running kernel environment.

The term “digital wallet,” as used hereinbelow, is both a software and information component. Digital wallets may be stored on a client-side. The digital wallets may use a Near Field Communication (NFC), e.g., of smartphones, to transfer payments by touching the smartphone to a payment terminal at a store.

The term “loyalty club customer” as used hereinbelow is a business to business (B2B) customer who has a loyalty club offering and operates a loyalty-based mobile service, e.g., a loyalty card application for his customer base.

The term “Back-End Platform” as used hereinbelow, is a cloud platform, backend server, of the digital wallet system, which is configured to manage and control the digital wallet services and to interact with selected third-party systems, and with the digital wallet module and/or digital wallet engine and/or digital wallet SDK.

The term “digital wallet SDK” as used hereinbelow, may include the digital wallet module and/or the digital wallet engine. The digital wallet SDK is the front-end of the digital wallet software program, which resides and is integrated within a custom mobile application. The digital wallet SDK may manage the front-end payment interaction of the end-user through the customer's mobile application. The digital wallet SDK may use an NFC protocol to communicate with a POS Terminal of the vendor POS on behalf of the digital wallet platform.

The term “customer relationship manager (CRM) application programming interface (API),” as used hereinbelow, is an API configured to communicate with a the CRM. The CRM is configured to manage one or more customer rewards programs.

The term “Payment terminal,” as used hereinbelow, may include, for example, the credit card terminal of a specific merchant and/or vendor and/or shop and/or etc., on which various payment transactions can be made when an End-User decides to consume a payment transaction using his Consumer Mobile application.

The term “Customer Platform,” as used hereinbelow, may include, for example, the technology platform of a customer of a partner which is configured to engage with the digital wallet for the provision of payments through the digital wallet platform. The backend technology platform communicates with the Customer Mobile Application as well as with the digital wallet SDK, depending on the payment configuration chosen by the customer and/or partner. For example, this platform will be cloud-based, running on, for example, Amazon Web Services (AWS) and/or Microsoft AZURE.

The term “cryptowallet module,” as used hereinbelow, may refer to an application or an SDK that is configured to generate and store random private-public key pairs with a respective crypto-wallet address generated from the public key. The crypto wallet module may be further configured to interact with at least one blockchain network such as the Ethereum blockchain and other similar blockchain networks such as Bitcoin, Solana, Cardano, Polkadot, Avalanche, etc.

The term “hash value” refers to an output of a mathematical function which takes an input of arbitrary length and transforms it to a fixed length, such that even a negligible difference in input results in a completely different hash value for an output but applying the hash function to the same input always results in the same hash value. Hash values are used to validate the contents of messages. When the content is changed, the hash value of the new message will be different from the original message.

The term “Payment token,” as used hereinbelow, may include a unique placeholder called a payment token which is configured to include information uniquely identifying a user, for example, encrypted with known public-private algorithms such as the Rivest-Shamir-Adleman—‘RSA’ algorithm.

In some embodiments, a payment token may be comprised of a public key representing an address on a blockchain network owned by a user and other identifying information, such as, for example, a name, contact information, a mobile device metadata, a time, geolocation data, etc.

For example, if unique identifiable information of a user is parsed in a simple JSON format containing the following:
{“address”: “0xb794f5ea0ba39494ce839613fffba74279579268”, “name”=“John Smith” }, the payment token may then contain the following encrypted string:
NjXlHoGdktQHFF5hJ0Psy+SJmOhCTEgcYFVvpJCwuoR6TDQjmTMJI6G+/lCf2mWYswjCz/6pSW/90EQmzp6Xiv4x8maycBsVwNIPa2t4dcWAGK0D9n5mkU aA2tz+pk1FrOYq4ttrLZc7pNzCaDpcNyOa8ZEnwAA7TSqNfsvgXfw=.

In another example implementation, only identifiable information is encrypted while the public address is parsed in the JSON file as-is. Where the identifying string is: “name: John Smith”, The JSON file shall read:
{“address”: “0xb794f5ea0ba39494ce839613fffba74279579268”, “idInfo” “XFftAh5RGXtlzJ622+vrg2nUBozV97KdyHRL300xBIGdiCRzf4h+bsxbYGFqCxH zLp4HidpJAc3PvzjPwE1AuQ==” }

The above is only an example to clarify the terminology used herein. In practice, additional parameters may be included in the payment token, including a single-use random number that is also stored in a database of the back-end platform to ensure that the hashed part of the payment token remains unique for each use.

The term “mobile application,” as used hereinbelow, may include at least one application that is installed on the customer's wireless device, for example, the loyalty club application, e-Wallet application, or the like. The customer application may include the digital wallet SDK and may interact with the digital wallet platform and the customer platform. The customer mobile application may be configured to run on a wireless device operating system, such as, for example, iOS and/or Android.

Some demonstrative embodiments may build on the web3 ecosystem concept and blockchain technology. For example, the web3 ecosystem concept and blockchain technology establish a secure, transparent, and decentralized payment system. The use of a blockchain enables consumers and businesses to directly exchange cryptocurrency, such as, for example, Bitcoin and Ethereum, via crypto wallets without intermediaries. The payment is verified and anonymously registered on a distributed ledger, wherein, for example, a copy of which may be stored on a crypto wallet.

For example, the ownership verification of the crypto-wallet and its funds may be achieved by using private-public keys, as the basic assumption is that only the owner of the crypto wallet has access to the private key, making the public key available for use as a unique wallet identifier.

More than a decade after the first implementation of the Bitcoin blockchain, the technology struggles to gain adoption as a consumer payment method and remains mostly a speculative investment channel.

There are many reasons why Blockchain technology and cryptographic currency have yet to achieve the purpose of becoming a viable alternative to traditional centralized payment means and legal tender.

Some of those reasons, for example, pertain to energy inefficiencies inherent in the blockchain design. Others relate to the anonymous nature of transactions that pose a platform for money laundering activities, yet another reason pertains to the high transaction fees awarded to transaction verifiers.

Embodiments of the disclosure may be related to systems, apparatuses, and methods for verifying payment validity, avoiding the use of complex standards for handling the transmittal of sensitive credit card information. For example, instead of transmitting or using sensitive credit card numbers, using cryptographic public-private key authentication in combination with point-of-sale terminals configured to process the public keys and validate ownership and payments, may lead to savings and simpler systems, as the use of complex standards handling transmittal of sensitive credit card information (e.g., EMV) may now be avoided.

Other embodiments may be related to systems, apparatuses, and methods that enable ownership verification of a public unique consumer identifier. For example, due to the nature of public-private cryptography, there is no reason to transmit sensitive secret information such as credit card number, expiration date, CVC digits and a 4-digit PIN to prove ownership. Instead, a public key may be transmitted with additional information, whereas the present disclosure introduces apparatuses, systems, and methods that enable a consumer to prove ownership of the transmitted public key.

However, some embodiments may also be configured to enable crypto-wallets-based payment verification with no blockchain-related fee costs. Although blockchain-based payments may be considered secure, having to record each payment in public distributed ledger for payment verification purposes may be considered inefficient. With the use of the present disclosure, many of the public who already have access to crypto-wallets as blockchain network clients may use their wallets to buy goods and services with their crypto-wallets but with none of the fees associated with cryptocurrency transactions and with no privacy concerns, since their purchase will not be published in a distributed public ledger.

Advantageously, the configuration of the devices and systems therein allows authenticating ownership of a payment account in multi-factor authentication while only requiring a single action from the user.

For example: when a user brings his smartphone's Near Field Communication (NFC) chip close to a payment terminal device at checkout, he performs a single action. An application containing a Software Development Kit (SDK) shall send a payment token with a public key representing the user to a payment terminal, which will be relayed with checkout information from the payment terminal to the server. After cross-referencing the received payment token and public key in a user database and associating it with a user, the server may relay the transaction information to a smartphone pre-associated with the user.

Upon realization of pre-set conditions (e.g., if a smartphone screen is unlocked, geolocation of the smartphone is similar to the payment terminal), the SDK shall use the private key corresponding to the public key and sign the transaction message previously received, and return the signed transaction message back to the server. The server then may decrypt the received signed message and may compare multiple parameters of the signed message with a database entry. The multiple parameters may include at least one of the following: a public key derived from the signed message and the public key previously received with the payment token; content of a signed message and transaction information received from a payment terminal; user information of the payment token received from the payment terminal and the user information gathered on a first registration

As it can be seen, while the user was required to perform only a single action, his identity and the transaction were verified in multi-factor authentication, utilizing the properties of the public-private authentication from two different perspectives. The first perspective is when comparing the public keys of the payment token with the public key provided during registration. The second perspective is when comparing the payment token public key with a signed message by a corresponding private key.

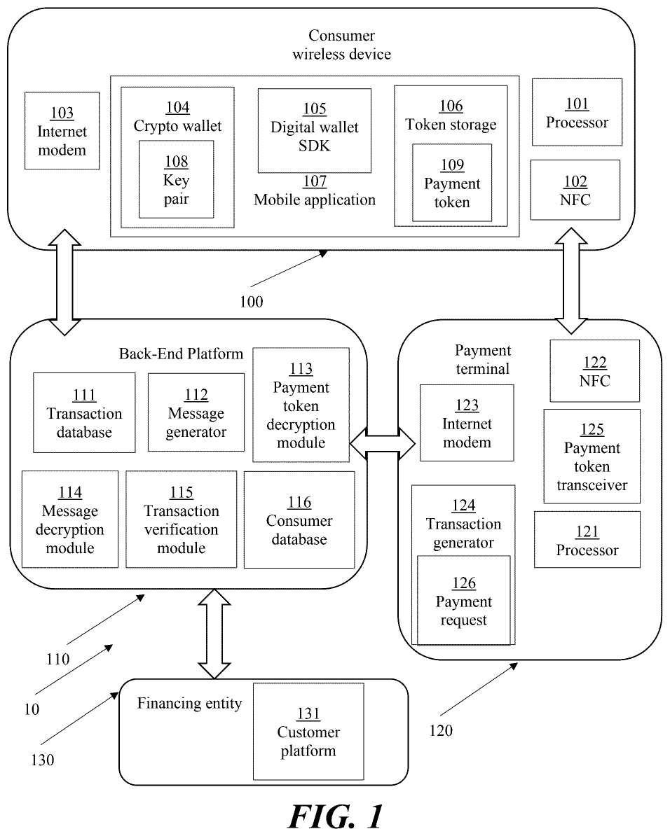

Referring initially to FIG. 1 depicting a demonstrative embodiment of the present invention, a system 10 for verifying payment validity. The system 10 may include at least one Consumer wireless device 100, a Back End Platform 110, an at least one payment terminal 120, and a Customer platform 131 of a Financing entity 130.

In some demonstrative embodiments, the wireless device 100 may include a processor 101, an NFC communication suite 102, an Internet modem 103, a crypto-wallet application 104, a digital wallet SDK 105, a payment token storage module 106. The processor 101 may be configured to run at least one of a mobile application 107 that may include the digital wallet SDK 105 and Crypto wallet module 104. The mobile application 107 may be configured to interact with a blockchain network such as, for example, the Ethereum blockchain.

In some demonstrative embodiments, the crypto wallet 104 may include at least one public-private key pairs 108 and the payment token storage module 106 includes at least one payment token 109.

In some demonstrative embodiments, the internet modem 103 may use common wireless communication protocols such as, for example, 60 Ghz, 5G, 6G, WiFi, any one of the cellular communication protocols, any one of the IEEE 811 protocols, and the like.

In some demonstrative embodiments, the payment terminal 120 of a merchant POS may include, for example, processing circuitry 121, an NFC communication suite 122, an Internet modem 123, a transaction generator module 124 for generating at least one payment request message 126, and a payment token transceiver module 125.

For example, the processing circuitry 121 may be configured to run an application that includes transaction generator module 124, and the payment token transceiver module 125.

The payment terminal 120 may be in digital communication with the Back-end Platform 110 and with a Consumer wireless device 100.

For example, the Back-end Platform 110 may be in digital communication with one or more payment terminals 120, consumer wireless devices 100, and with a Customer platform 131 of various Financing entities 130. The Back-end Platform 110 may include transaction database 111, a message generator module 112, consumer database 116 processing circuitry (not shown) that may be configured to perform the functions of a payment token decryption module 113, a message signature decryption module 114, and a transaction verification module 115.

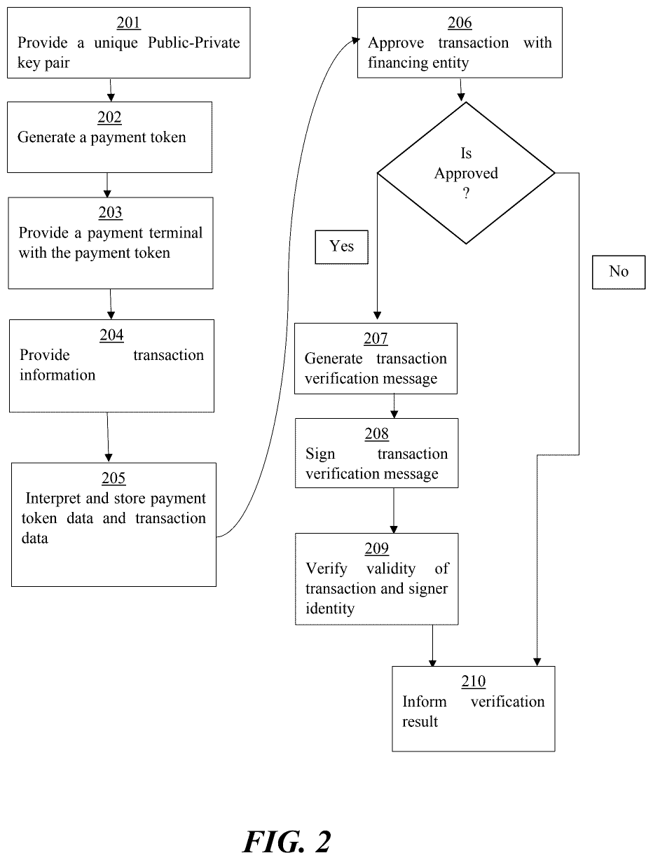

Referring to FIG. 2, an exemplary implementation of some embodiments will be understood from the following method. For clarity, structural components are referred to by their references in FIG. 1, though this method can be performed with other embodiments of the present invention.

The method for verifying payment validity may include: providing a Public-Private key pair 108 (text box 201), for example, by using the mobile application 107 installed on a Consumer wireless device 100.

In some demonstrative embodiments, upon a user signing into the mobile application, a command is passed to the Crypto-wallet module 104, which may be configured to produce a Public-Private key pair 108 (FIG. 1) which may include a public key and a private key. In some embodiments, the public key of the Public-Private key pair 108 (FIG. 1) may be used to create a crypto-wallet address in a process compliant with at least one blockchain network.

In some other demonstrative embodiments, the Public-Private key pair 108 (FIG. 1) may be generated before verifying each payment. In yet other embodiments, the Public-Private key pair 108 may be generated upon first registration of the user with the mobile application 107. In other embodiments, the user may import an existing Public-Private key pair into the Crypto-wallet module 104 (FIG. 1).

In some demonstrative embodiments, the method may proceed with generating a payment token 109 for payment validity verification (text box 202) by the mobile application 107 (FIG. 1) that may be installed on a Consumer wireless device 100 (FIG. 1). In some embodiments, the public key and/or the crypto-wallet address and/or any other user-identifying information may be passed to the payment terminal 120 (FIG. 1) for generating the payment token.

In some demonstrative embodiments, the payment token 109 (FIG. 1) includes the public key and a user ID associated with the consumer wireless device.

In other demonstrative embodiments, the payment token 109 (FIG. 1) may be generated by the Digital wallet SDK 105 (FIG. 1) and may be stored within the payment token storage database 106 (FIG. 1).

In some embodiments, the digital wallet SDK 105 (FIG. 1) may retrieve a public key of a public-private key pair 108 (FIG. 1) from the crypto-wallet module 104 (FIG. 1) and thereafter may generate the Payment token 109 (FIG. 1) therewith. In this embodiment, the private key of the public-private key pair 108 (FIG. 1) may remain securely stored within a database on the consumer wireless device 100 (FIG. 1), and the public key of the public-private key pair 108 (FIG. 1) may also be later forwarded and stored within a consumer database 116 (FIG. 1) on the Back-end Platform 110 (FIG. 1), and on the payment terminal 120 (FIG. 1).

In some demonstrative embodiments, the method may proceed with providing payment terminal 120 (FIG. 1) with the payment token 109 (FIG. 1) of a Consumer wireless device 100 (FIG. 1) (text box 203). In some embodiments, the payment token may be sent from the Consumer wireless device 100 (FIG. 1) to a payment terminal 120 (FIG. 1) via at least one of the following: NFC radio 102 (FIG. 1) and/or internet modem 103 (FIG. 1) (e.g., LTE, GSM, WIFI, Bluetooth radio).

In some demonstrative embodiments, the method may proceed with providing transaction information (text box 204). For example, the processing circuitry 121 (FIG. 1) of the payment terminal 120 (FIG. 1) may be configured to generate a payment request 126 (FIG. 1) that includes a transaction information message message such, for example, as payment due, product list, and/or merchant ID and the Payment Token 109 (FIG. 1). The payment request 126 may be sent to the Back-End Platform 110 (FIG. 1) provided by the Consumer wireless device 100 via the Internet modem 123 (FIG. 1).

Following is an illustrative example: when scanning products, their price and other information are fetched by the payment terminal 120 (FIG. 1). Information relating to a payment request may be displayed on the payment terminal 120 (FIG. 1), after the consumer has attached and/or brought his wireless device 100 (FIG. 1) closer to the payment terminal 120 (FIG. 1), and providing the payment terminal 120 (FIG. 1) with his payment token 109 (FIG. 1) via NFC communication. The payment terminal 120 (FIG. 1) may sum and provide a payment request 126 (FIG. 1) that includes a transaction information message. For example, the transaction information may include the payment due, the merchant ID. In some embodiments, the payment terminal 120 (FIG. 1) may be configured to send the transaction information message and/or a hash value thereof also to the consumer wireless device 100 (FIG. 1) for validation before signing a message.

In some demonstrative embodiments, the method may proceed with interpreting and storing payment token 109 (FIG. 1) data and the transaction information message of the payment request message (text box 205). For example, the interpreting may be done by a payment token decryption module 113 (FIG. 1) and the storing may be done into a transaction database 111 on the Back-End Platform 110 (FIG. 1).

In some demonstrative embodiments, where the payment token 109 (FIG. 1) may be encrypted with a public key associated with a service provider, the payment token 109 (FIG. 1) may be decrypted with a corresponding private key fetched by the payment token decryption module 113 (FIG. 1).

In some demonstrative embodiments, the method may proceed with approving the transaction with a financing entity 130 (FIG. 1) (text box 206). For example, transaction information and the identity of the consumer may be digitally forwarded to a customer platform 131 (FIG. 1) of financing entity 130 (FIG. 1). In some demonstrative embodiments the consumer holds a credit card issued by the financing entity 130, a banking account, and/or he is a member of a consumer loyalty program managed by the financing entity 130 (FIG. 1).

For example, after verifying if the transaction conforms to predefined rules, such as, for example, whether the consumer has sufficient credit or assets to cover for the transaction, the financing Entity 130 (FIG. 1) may confirm the transaction by returning a predetermined code message.

In some demonstrative embodiments, the transaction information message may be compared against various rules, such as, for example, whether the purchased product may be listed in a list of eligible products and/or whether, the merchant may be listed in a certain list of eligible businesses.

In some demonstrative embodiments, the method may proceed with generating a transaction verification message by the back-end platform 110 (FIG. 1) and providing it to the consumer associated with the corresponding payment token 109 (FIG. 1) (text box 207).

For example, the transaction verification message contains information related to the payment that may include a merchant ID and payment due. The transaction verification message may be generated by the message generator module 112 (FIG. 1) and may be sent, for example, to an address associated with the consumer, such as, for example, the mobile application 107 (FIG. 1) may be installed on the consumer's wireless device 100 (FIG. 1), a phone number, and/or an email address.

In some demonstrative embodiments, the method may proceed with signing the transaction verification message and sending it to the Back-End Platform 110 (FIG. 1) for decryption (text box 208). For example, the details of the transaction may be presented to the consumer using the user interface of the mobile application 107 (FIG. 1) for his confirmation (e.g., pressing a confirm button) before signing the message.

In another example, the digital wallet SDK may proceed with signing the message upon fulfillment of at least one of the conditions or rules. For example, the rules may include a rule for a hash value of the second message matches the hash value previously received first message from the payment terminal in connection with this transaction, a rule for when the consumer wireless device is unlocked, and a rule for whether the geolocation of the wireless device is within a predetermined range of a known geolocation of a payment terminal, a rule for whether the transaction to be signed does not exceed periodical allowance set by the consumer or on his behalf, and etc.

In some embodiments, the predetermined range of said known geolocation is between zero to five meters from the center of the known geolocation.

In some demonstrative embodiments, the transaction verification message may be signed with the private key of the public-private key pair and may be sent back to the Back-End platform 110 (FIG. 1).

In some demonstrative embodiments, the message decryption module 114 (FIG. 1) may decrypt the signed transaction verification message with the public key associated with the consumer.

In other embodiments, the message decryption module 114 (FIG. 1) may apply a suitable algorithm to derive the content of the signed transaction verification message and the public key corresponding to the private key that may be used to sign the message all without revealing the same private key. The process of decrypting a message signed by a private key may be, for example, according to EIP 712 Ethereum standard. Of course, other suitable algorithms may be contemplated to achieve the same result.

In some demonstrative embodiments, the method may proceed with verifying the identity of the signer of the transaction verification message and the validity of the transaction (text box 209). For example, the transaction verification module 115 (FIG. 1) may compare the decrypted verification message against the transaction information message previously received from the payment terminal. If a match is found, then the identity of the person that signed the message with the transaction information is verified because the received signed message may be signed using the ‘consumer’s private key and decrypted with his public key from the transaction database 111 (FIG. 1).

In another example, the transaction verification module 115 (FIG. 1) may compare the public key parameters and the verification message from the decrypted signed message against the same from the transaction database 111 (FIG. 1).

In some demonstrative embodiments, the method may proceed with informing transaction results (text box 210). For example, the Back-End Platform 110 (FIG. 1) may inform the consumer, merchant, and the Financing entity 130 (FIG. 1) of the outcome of payment validity verification by sending a transaction confirmation message, thus, allowing for the exchange of goods, services and money or preventing an unverified transaction.

It should be understood that the method may be performed in a different order or concurrently, so the order of the method operation described hereinabove have no importance.

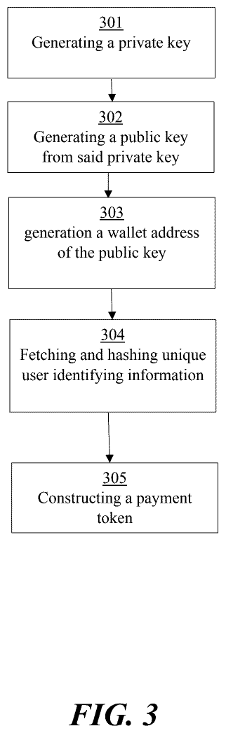

Referring to FIG. 3, which is a flowchart illustration of a method for generating a payment token according to some demonstrative embodiments. In some demonstrative embodiments, this method may be performed by a digital wallet SDK 105 (FIG. 1) included in a mobile application 107 (FIG. 1) installed on a consumer wireless device 100 (FIG. 1). In some other embodiments, the following method may be performed by the payment terminal 120 (FIG. 1).

In some embodiments, a crypto-wallet module 104 of consumer wireless device 100, may generate and store a random public-private key pair 108.

In some demonstrative embodiments, the method may start with generating a private key (text box 301) by generating a random number that may be suitable as an input to an algorithm used to generate the public key.

In some demonstrative embodiments, the method may proceed with generating a public key based on the private key (text box 302) by hashing the private key with, for example, an algorithm as the Elliptic Curve Digital Signature Algorithm.

In some demonstrative embodiments, the method may proceed with generating a wallet address of the public key (text box 303) by formatting the public key to a predetermined format used for identifying a set of characters as a crypto-wallet address. For example, extracting the last 20 bytes of the public key and adding ‘Ox’ at the beginning.

In some demonstrative embodiments, the method may proceed with fetching and hashing unique consumer identifying information (text box 304). In some embodiments, the identifying information may include at least one of the following: consumer contact information (e.g., name, phone number, email), wireless device ID (e.g., IMEI number), payment information (e.g., bank account, credit card), geolocation, and consumer ID number.

In some demonstrative embodiments, the back-end platform 110 (FIG. 1) may generate a unique random number, store the unique random number in the user database and send it securely for inclusion as a nonce when constructing a payment token. This feature prevents generating identical payment tokens where there was no change in identifying information.

The method may proceed with constructing a payment token that includes the public key and the hash value of the unique user information (text box 305). In some embodiments, the public key or the crypto-wallet address may be structured with the hash value of the consumer identifying information into a common suitable data structure, such as, for example, a JSON file, readable by the back-end platform 110.

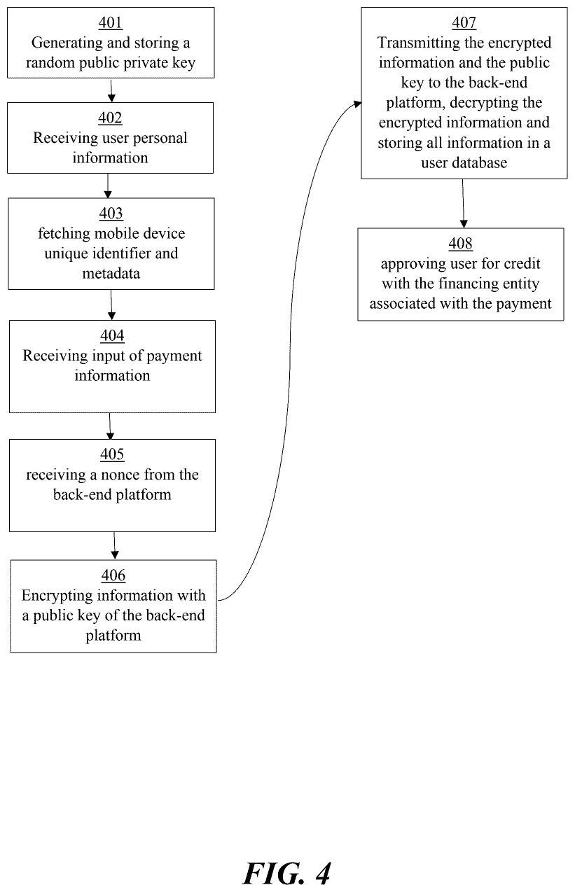

Referring to FIG. 4, which is a flowchart illustration of a method for initial user registration for a service, according to some demonstrative embodiments. In some demonstrative embodiments, this method is performed by a digital wallet SDK 105 (FIG. 1) which may be included in a mobile application 107 (FIG. 1) installed on a consumer wireless device 100 (FIG. 1).

In some demonstrative embodiments, the method may begin with generating and storing a random public-private key pair 108 (FIG. 1) with the digital wallet SDK 105 (FIG. 1) and the crypto-wallet (text box 401) and proceed with receiving input from the user personal information (text box 402). For example, the personal information may include at least one of the following: name, phone number, address, email address, birthday date, and/or facial photograph.

In some demonstrative embodiments, the method may proceed with fetching wireless device unique identifier and metadata (text box 403). This information may include at least one of the following: IMEI number of the wireless device running the digital wallet SDK, device model, operating system version, and SDK version.

In some demonstrative embodiments, the method may proceed with receiving input of payment information (text box 404). This information may include at least one of the following: credit card information, bank account number, loyalty program information.

In some embodiments, payment information may be received via an interface to an application of the financing entity installed on the wireless device, such as, for example, a bank mobile application, a loyalty program mobile application, etc.

In some embodiments, payment information may be received via an interface to a browser installed on the wireless device when logging in with a website of the financing entity.

Optionally, requesting and receiving a nonce from the back-end platform (text box 405).

For example, encrypting information including personal information, device information, payment information, and nonce with a public key of the back-end platform 110 (text box 406).

In some demonstrative embodiments, the method may proceed with transmitting the encrypted information and the public key generated by the digital wallet SDK 105 (FIG. 1) to the back-end platform 110 (FIG. 1), decrypting the encrypted information with the required private key and storing all information in a consumer database 116 (FIG. 1) in the back-end platform 110 (FIG. 1) (text box 407).

In some embodiments, the method further comprises approving the user for credit with the financing entity 130 (FIG. 1) associated with the payment information (text box 408). For example, if bank account information was entered, the back-end platform 110 (FIG. 1) may query the associated customer platform 131 (FIG. 1) of the bank to confirm that the bank will cover transactions requested by that user and under what rules (e.g., accept only domestic transactions).

In some demonstrative embodiments, the method may comprise, generating a user ID for an approved and/or registered user, encrypting it with the public key of the public-private pair 108 (FIG. 1) provided by the user, and transmitting the encrypted user ID to the wireless device 100 (FIG. 1) of the user for decryption with the appropriate private key of the public-private pair 108 (FIG. 1), and storage with the public key in the payment token storage 106 (FIG. 1) for use as a payment token 109 (FIG. 1) in future transactions.

In some embodiments, the user ID may include at least one random number, a unique serial number, a hash value of user information arranged in a specific order

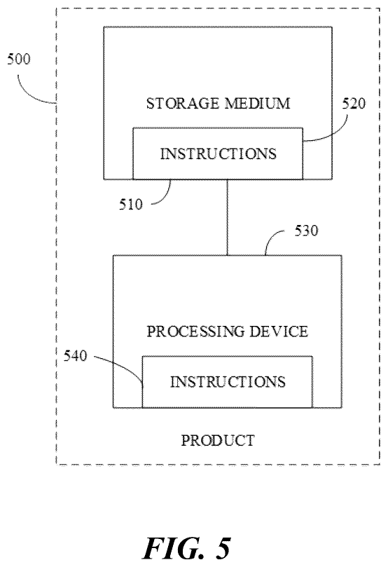

Reference is now made to FIG. 5, which is a schematic illustration of a product of manufacture 500, according to some demonstrative embodiments. Product 500 may include one or more tangible computer-readable non-transitory storage media 510, which may include computer-executable instructions 530, implemented by processing device 520, operable to, when executed by at least one computer processor, enable the at least one processing circuitry 121 (FIG. 1) to implement one or more program instructions for verifying payment validity and/or to perform, trigger and/or implement one or more operations, communications and/or functionalities as described above with reference to FIGS. 1-4. The phrase “non-transitory machine-readable medium” is directed to include all computer-readable media, with the sole exception being a transitory propagating signal.

In some demonstrative embodiments, product 500 and/or machine-readable storage medium 510 may include one or more types of computer-readable storage media capable of storing data, including volatile memory, non-volatile memory, removable or non-removable memory, erasable or non-erasable memory, writeable or re-writeable memory, and the like. For example, machine-readable storage medium 510 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusion drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 520 may include logic. The logic may include instructions, data, and/or code, which, if executed by a machine, may cause the machine to perform a method, process, and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 520 may include or may be implemented as software, firmware, a software module, an application, a program, a subroutine, instructions, an instruction set, computing code, words, values, symbols, and the like. Instructions 540 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled, and/or interpreted programming languages, such as C, C++, C#, Java, Python, BASIC, Mat lab, assembly language, machine code, and the like.

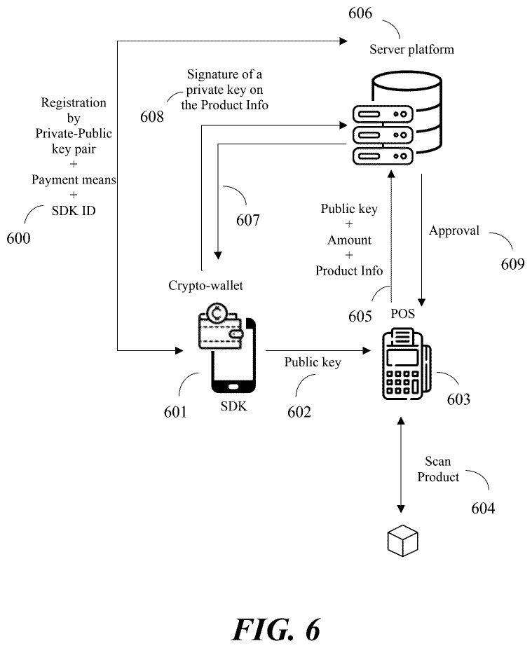

Referring to FIG. 6 depicting a demonstrative embodiment of the present invention. The exemplary process depicted herein, may start with a registration stage 600 that may include the SDK 601 gathering and sending to a server platform 606, consumer information 600 such as private-public key pair from the crypto-wallet, payment means such as credit-card information, and SDK ID that may be a unique identifier.

When the consumer approaches a POS 603 to purchase scanned products 604, he may display the device with the SDK 601 which may result in sending the public key in a payment token to the payment terminal of the POS 603.

The process may proceed with the POS sending to the server platform 606 a payment request that may include the public key and a transaction information message (e.g., total payment amount) 605.

The process may proceed with the server platform 606 sending the SDK 601 identified by the payment token or the public key, a transaction verification message 607 that may include such details previously provided by the transaction information message.

The process may proceed with the SDK 601 signing the transaction verification message after consumer approval and transmitting 608 to the server platform 606.

The process may proceed with the server platform 606 validating the payment based on comparison of information between the SDK 601 signed transaction verification message and the transaction information message provided by the POS 603.

The process may proceed with the server platform 606 informing the POS 609 of approval or rejection of payment. The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

What is claimed:

1. A method for verifying payment validity executed by a wireless device comprising:
producing a Public-Private key pair by a crypto wallet;
generating a payment token that includes a public key of said Public-Private key pair;
transmitting said payment token to a payment terminal at a point of sale; wherein said payment terminal is configured to generate a payment request that includes a transaction information message of a payment and the payment token and to transmit thereafter the payment request to an at least one backend platform;
generating a transaction verification message by said at least one back-end platform based on said transaction information message;
providing the transaction verification message to a device associated with said public key of said payment token;
signing said transaction verification message with a private key of said public-private key pair and sending the signed transaction verification message to said at least one back-end platform;
verifying ownership of said first public key by comparing a public key of the transaction verification message signed by said wireless device against said public key included in the payment request message generated by said payment terminal, by the at least one back-end platform;
approving said payment with a customer platform of an at least one financing entity;
informing any of said payment terminal, wireless device, and said customer platform of payment verification result by said at least one back-end platform by sending a transaction confirmation message from said at least one back-end platform.

2. The method of claim 1, wherein said consumer identifying information of said payment token is at least one of the following: a random number stored in said at least one back-end platform, a hash value of information associated with a consumer, a unique serial number.

3. The method of claim 1, wherein said transaction information message comprises at least one of a payment due, a product list, and a merchant ID.

4. The method of claim 1, wherein generating said payment token comprises:
generating a private key that is a random number;
generating a public key by hashing said private key;
hashing consumer identifying information that includes at least one of the following: consumer contact information, wireless device ID, payment information, geolocation, and consumer id number;
constructing said payment token with said public key and the hash value of the consumer identifying information.

5. A payment terminal comprising one or more tangible computer-readable non-transitory storage media comprising program instructions for verifying payment validity, wherein execution of the program instructions by one or more processors cause the payment terminal to:
receive a payment token issued by a software development kit (SDK) located at a wireless device, wherein the payment token includes a public key of a pair of Public-Private keys produced by a crypto wallet;
generate a payment request that includes a transaction information message and said payment token, and transmit said payment request to an at least one back-end platform; and
receive a payment and a transaction confirmation message from said at least one back-end platform based on a payment approval generated by said at least one back-end platform; wherein verifying ownership of said public key is done by at least one back-end platform based on comparison of the public key of the transaction verification message signed by a private key of the Public-Private key pair in the wireless device and the public key included in the payment request generated by said payment terminal.

6. The payment terminal of claim 5, wherein executing said program instructions by one or more processors cause the payment terminal to:
receive said payment token via an at least one of: a Radio Frequency Identification (RFID) communication, a short-range radio communication and a Near Field Communication (NFC).

7. The payment terminal of claim 5, wherein said payment token comprises consumer identifying information that includes at least one of the following: a random number stored in said at least one back-end platform, a hash value of information associated with a user, a unique serial number.

8. The payment terminal of claim 5, wherein said transaction information message comprises at least one of: a payment due, a product list, and a merchant ID.

9. A wireless device comprising one or more tangible computer-readable non-transitory storage media having installed an application comprising program instructions for verifying payment validity wherein execution of the program instructions by one or more processors results in:
producing a Public-Private key pair by a crypto wallet;
generating a payment token comprising a public key of said Public-Private key pair;
transmitting said payment token to a payment terminal of said point of sale;
receiving a transaction information message from said payment terminal;
receiving a transaction verification message from at least one backend platform;
based on comparison of a transaction information message received from said payment terminal and said transaction verification message generated by said at least one back-end platform, signing said transaction verification message with a private key of said public-private key pair, and sending said signed transaction verification message to said at least one back-end platform; and
receiving a transaction confirmation after verifying ownership of said public key based on comparison of the public key of the signed transaction verification message and said payment token by said at least one backend platform.

10. The wireless device of claim 9, wherein said payment token comprises consumer identifying information that is comprised of at least one of: a random number stored in said at least one backend platform, a hash value of information associated with a consumer.

11. The wireless device of claim 9, wherein, said program instructions of said storage media when executed by one or more processors results in:
generating a payment token before each payment to be verified.

12. The wireless device of claim 9, wherein, said program instructions of said storage media when executed by one or more processors results in:
generating a private-public pair upon first registration of a consumer with said at least one backend platform.

13. The wireless device of claim 9, wherein, said program instructions of said storage media when executed by one or more processors results in:
importing an existing Public-Private key pair for use in said payment token.

14. The wireless device of claim 9, wherein, said program instructions of said storage media when executed by one or more processors results in:
signing said transaction verification message on at least one of the events of unlocking said wireless device, when a geolocation of the wireless device is within a predetermined range of a known geolocation of a payment terminal, whether a transaction to be signed does not exceeds a pre-set allowance.

15. The wireless device of claim 14, wherein said predetermined range of said known geolocation is between zero to five meters from the center of the known geolocation.

16. The wireless device of claim 9, wherein said program instructions of said storage media when executed by one or more processors results in:
generating a private key that is a random number;
generating a public key by hashing said private key;
hashing consumer identifying information;
constructing said payment token with said public key and the hash value of the consumer identifying information.

17. The wireless device of claim 10, wherein said consumer identifying information comprises at least one of: a consumer contact information, a wireless device ID, payment information, geolocation, and consumer id number.
